(19) United States
(12) Patent Application Publication
(10) Pub. No.: US 2024/0209978 A1
(43) Pub. Date: Jun. 27, 2024

(54) Protective Case With Kickstand

(71) Applicant: Elvis Ramirez, Wilmington, NC (US)

(72) Inventor: Elvis Ramirez, Wilmington, NC (US)

(21) Appl. No.: 18/088,275

(22) Filed: Dec. 23, 2022

(51) Int. Cl. F16M 11/06; A45C 11/00; F16M 11/28

(52) U.S. Cl. CPC F16M 11/06; A45C 11/00; F16M 11/28; A45C 2011/002; A45C 2200/15

(57) ABSTRACT

The cellphone kickstand case is the only product of its kind that is equipped with a kickstand that also operates as a vent clip to allow users to easily and conveniently prop their phones on a surface “hands-free” to view content in both landscape or portrait mode. This unprecedented device is uniquely designed with a rugged rubber and plastic material to ensure long-term sustainability, is carefully crafted with a durable flexible material that permits the option to expand and flex the accessory to fit in a variety of vehicle air vents without causing damage to either the product or vehicle during utilization.

### BACKGROUND

In recent years, there has been an increase of “hands free” usage of cellular devices, specifically when operating an automobile, in effort to improve safer and attentive driving. To do this, individuals, are often required to purchase a new accessory or device to hold their mobiles which can be inconvenient and costly. There have been no products available as original equipment or as an aftermarket to address this problem.

An apparatus to increase the capability to use your mobile device “hands-free” both inside a vehicle and out, is not being met by any known device or system at present. There have been no products available as original equipment or as an aftermarket to address this problem either.

### SUMMARY OF THE INVENTION

The main purpose the protective case with kickstand is to provide users with a multi-purpose cell phone case with a rotating kickstand that also acts as a vent clip for cellphone replacement in vehicles.

A cell phone accessory, including a cell phone case having four lateral sides and a back configured to define a keyhole recess in a thickness thereof, a swivel joint configured flush with the back and to rotate three hundred and sixty degrees in a common plane with the back; and a leg configured to extend a first length from the swivel joint via a hinge and fold into the keyhole recess to be flush with the thickness and the back.

### BRIEF DESCRIPTION OF THE DRAWINGS

FIG. 1 is a back side perspective view of the protective case with kickstand closed in accordance with an embodiment of the present disclosure.

FIG. 2 is a back side perspective view of the protective case with kickstand with the kickstand out, in accordance with an embodiment of the present disclosure.

FIG. 3 is a back side perspective view of the protective case with kickstand with kickstand out and in a “hands-free” position, in accordance with an embodiment of the present disclosure.

FIG. 4 is a depiction of the swivel joint and leg hinge with extension and boss in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

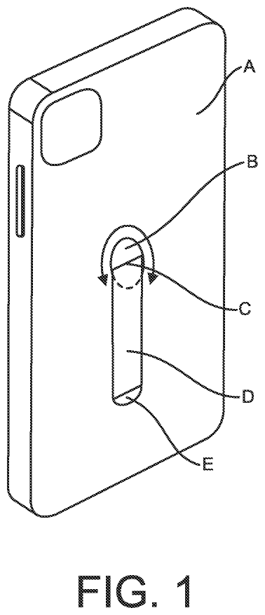

FIG. 1 is a back side perspective view of the protective case with kickstand closed showing: rubber case with hard plastic back and raised edges to protect screen and soft rubber edges referenced as A, rotating base, also known as a swivel joint referenced as B, hinge referenced as C, the leg or kick-stand/vent clip referenced as D, groove for stand/clip to click in flush, and the pry space E in accordance with an embodiment of the present disclosure.

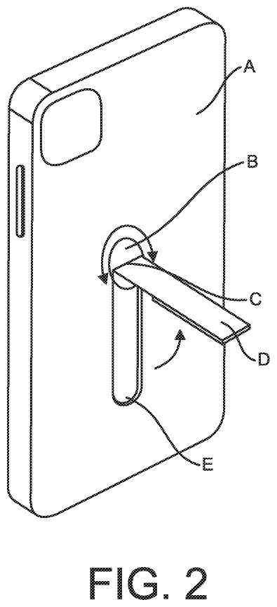

FIG. 2 is a back side perspective view of the protective case with kickstand with the kickstand out showing: rubber case with hard plastic back and raised edges to protect screen and soft rubber edges referenced as A, rotating base referenced as B, hinge referenced as C, kick-stand/vent clip referenced as D, groove for stand/clip to click in flush, in accordance with an embodiment of the present disclosure.

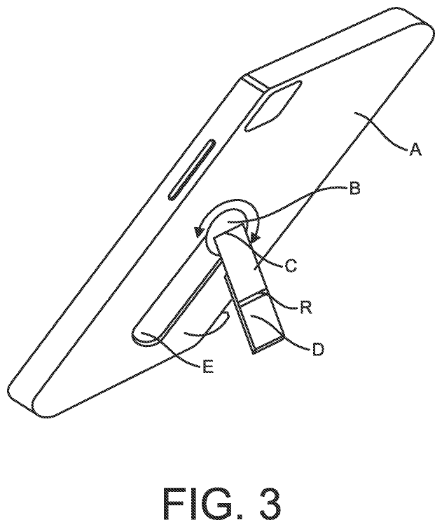

FIG. 3 is a back side perspective view of the protective case with kickstand with kickstand out and in a “hands-free” position showing: rubber case with hard plastic back and raised edges to protect screen and soft rubber edges referenced as A, rotating base referenced as B, hinge referenced as C, leg or kick-stand/vent clip referenced as D, groove for stand/clip to click in flush, and ridge R for disposing in a vehicle vent in accordance with an embodiment of the present disclosure.

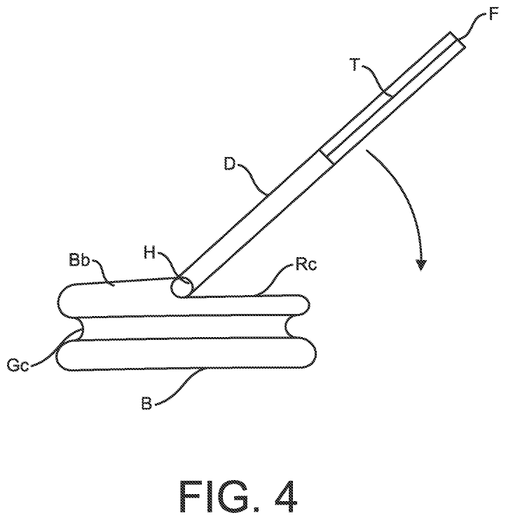

FIG. 4 is a depiction of the swivel joint and leg hinge with extension and boss in accordance with an embodiment of the present disclosure. The boss Bb limits the travel of the leg D about the hinge H. The leg D includes a telescoping extension T and a foot F and closes in the cutout Re in a top of the 80 swivel joint B. The circumferential groove Gc is complementary to a protuberance or a boss around the top of the keyhole recess defined in the cell phone case to secure it therein.

The present disclosed protective case with kickstand, also known as “The Cellphone Kickstand Case”, offers a modern accessory that not only provides protection to a cell phone but will also eliminate the need of buying extra accessories to hold a phone at an ideal position within a car. Expanding on the initial design of an average phone case, the cellphone kickstand case introduces a novel safeguarding option that provides multiple uses. The cellphone case will provide drop impact protection to the phone while the kickstand/vent clip part will allow users to easily and conveniently prop the phone on any surface “hands-free”. Users can place the kickstand into the vent using the strategically designed slit which will act as a vent clip sustaining the phone in their car, independently, to support “hands-free” operations, such as GPS navigation. This innovative, top-quality product enhances the functionality of an average phone case and allows consumers to use their cases as a propping tool for cellular devices, at their leisure.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A cell phone accessory, comprising:
a cell phone case having four lateral sides and a back configured to define a keyhole recess in a thickness thereof;
a swivel joint configured flush with the back and to rotate three hundred and sixty degrees in a common plane with the back; and
a leg configured to extend a first length from the swivel joint via a hinge and fold into the keyhole recess to be flush with the thickness and the back.

2. The cell phone accessory of claim 1, wherein a shape of the keyhole recess comprises a round portion and a slotted portion.

3. The cell phone accessory of claim 1, wherein the swivel joint further define a circumferential groove complementary to a circular boss in the back.

4. The cell phone accessory of claim 1, wherein the back further comprises a circular boss complementary to a circumferential groove defined in the swivel joint.

5. The cell phone accessory of claim 1, wherein the leg comprises a flat foot termination.

6. The cell phone accessory of claim 1, wherein the leg has a thickness less than the cell phone case thickness.

7. The cell phone accessory of claim 1, wherein the leg is configured to hinge from the swivel joint zero to one hundred and eighty degrees relative to the common plane.

8. The cell phone accessory of claim 1, wherein the leg further comprises a telescoping second length.

9. The cell phone accessory of claim 1, further comprising a pry space between an end of a slotted portion of the keyhole recess and the hinged leg.

10. The cell phone accessory of claim 1, wherein the swivel joint comprises a cutout for the leg to be received therein and be flush with back.

11. The cell phone accessory of claim 1, wherein a hinge of the leg shared with the swivel joint is configured to pull out for a movement and to fold flush with a storage therein.

12. The cell phone accessory of claim 1, wherein the leg is configured as a kick-stand for the cell phone case and a cell phone therein.

13. The cell phone accessory of claim 1, wherein the leg is configured as a vehicle air vent clip with a plurality of ridges therein.

14. The cell phone accessory of claim 1, wherein the leg rotates about the hinge and rotates about the swivel joint within a hemisphere of positions.

15. The cell phone accessory of claim 1, wherein the leg is limited in a rotation about the hinge by a boss in the swivel joint.
